(19) United States
(12) Patent Application Publication
(10) Pub. No.: US 2024/0373243 A1
(43) Pub. Date: Nov. 7, 2024

(54) METHOD FOR PERFORMING COEXISTENCE CONTROL BASED ON ADAPTIVE THRESHOLD ADJUSTMENT IN WIRELESS COMMUNICATION DEVICE CONFIGURED TO OPERATE WITH FIRST WIRELESS COMMUNICATION PROTOCOL AND SECOND WIRELESS COMMUNICATION PROTOCOL, AND ASSOCIATED WIRELESS COMMUNICATION DEVICE

(71) Applicant: MEDIATEK INC., Hsin-Chu (TW)

(72) Inventors: Chang-Yi Hsu, Hsinchu City (TW); Yu-Ming Wen, Hsinchu City (TW); Po-Hsun Huang, Hsinchu City (TW); Li-Tien Chang, Hsinchu City (TW); Chia-Ming Chang, Hsinchu City (TW)

(73) Assignee: MEDIATEK INC., Hsin-Chu (TW)

(21) Appl. No.: 18/653,904

(22) Filed: May 2, 2024

Related U.S. Application Data
(60) Provisional application No. 63/463,573, filed on May 3, 2023.

(51) Int. Cl. H04W 16/14; H04L 5/14

(52) U.S. Cl. CPC H04W 16/14; H04L 5/14

(57) ABSTRACT

A wireless communication device configured to operate with a first wireless communication protocol and a second wireless communication protocol and a method for performing coexistence control based on adaptive threshold adjustment in the wireless communication device are provided. The method may include: performing wireless communication operations with the first wireless communication protocol and the second wireless communication protocol concurrently; comparing a current throughput with a throughput threshold; in response to the current throughput being less than the throughput threshold, comparing a received signal strength indicator (RSSI), in communication using the second wireless communication protocol, with a signal strength threshold to generate at least one comparison result; and selectively sending a null frame according to the at least one comparison result, in order to temporarily avoid communication using the second wireless communication protocol.

### CROSS REFERENCE TO RELATED APPLICATIONS

This application claims the benefit of U.S. Provisional Application No. 63/463,573, filed on May 3, 2023. The content of the application is incorporated herein by reference.

### BACKGROUND

The present invention is related to communication control, and more particularly, to a method for performing coexistence control based on adaptive threshold adjustment in a wireless communication device configured to operate with a first wireless communication protocol and a second wireless communication protocol, and the associated wireless communication device such as a station (STA) device.

According to the related art, a wireless communication device may be designed to provide a Wi-Fi communication service and a Bluetooth communication service, for example, by using the same radio frequency band such as the 2.4 gigahertz (GHz) band. When a user of the wireless communication device have some activities related to the Wi-Fi and the Bluetooth communication services at the same time, one or more problems such as interference may occur. Although the wireless communication device may be designed to provide the Wi-Fi communication service by using another radio frequency band such as the 5 GHz band, the wireless communication device may need to provide the Wi-Fi communication service by using the 2.4 GHz band in certain situations. Some suggestions may be proposed to try solving the problems, but further problems such as some side effects may be introduced. For example, a certain solution may cause one or more side effects, and another solution may cause one or more other side effects. Thus, a novel method and associated architecture are needed for solving the problems without introducing any side effect or in a way that is less likely to introduce a side effect.

### SUMMARY

It is an objective of the present invention to provide a method for performing coexistence control based on adaptive threshold adjustment in a wireless communication device configured to operate with a first wireless communication protocol and a second wireless communication protocol, and the associated wireless communication device such as a STA device, in order to solve the above-mentioned problems.

At least one embodiment of the present invention provides a method for performing coexistence control based on adaptive threshold adjustment in a wireless communication device configured to operate with a first wireless communication protocol and a second wireless communication protocol. The method may comprise: performing wireless communication operations with the first wireless communication protocol and the second wireless communication protocol concurrently; comparing a current throughput with a throughput threshold; in response to the current throughput being less than the throughput threshold, comparing a received signal strength indicator (RSSI), in communication using the second wireless communication protocol, with a signal strength threshold to generate at least one comparison result; and selectively sending a null frame according to the at least one comparison result, in order to temporarily avoid communication using the second wireless communication protocol.

At least one embodiment of the present invention provides a wireless communication device configured to operate with a first wireless communication protocol and a second wireless communication protocol, where the wireless communication device may comprise a first communication control circuit and a second communication control circuit. For example, the first communication control circuit may be arranged to perform communication control in compliance with the first wireless communication protocol, and the second communication control circuit may be arranged to perform communication control in compliance with the second wireless communication protocol. The first communication control circuit and the second communication control circuit may be arranged to perform wireless communication operations with the first wireless communication protocol and the second wireless communication protocol concurrently. In addition, the second communication control circuit may be arranged to compare a current throughput with a throughput threshold. Additionally, in response to the current throughput being less than the throughput threshold, the second communication control circuit may be arranged to compare an RSSI, in communication using the second wireless communication protocol, with a signal strength threshold to generate at least one comparison result, and selectively send a null frame according to the at least one comparison result, in order to temporarily avoid communication using the second wireless communication protocol.

It is an advantage of the present invention that, through proper design, the method of the present invention and the associated apparatus such as the wireless communication device can adaptively adjust the signal strength threshold in a user phase of the wireless communication device, rather than tuning the signal strength threshold in at least one preliminary phase (e.g., a design phase, any pilot run phase among multiple pilot run phases, a mass production phase) of the wireless communication device, in order to correctly switch among multiple predetermined communication control strategies, and therefore enhance the overall performance. In addition, the method of the present invention and the associated apparatus such as the wireless communication device can perform an adaptive strategy control procedure for adaptively adjusting the signal strength threshold while performing the coexistence control on the first communication control circuit (e.g., BT control circuit) and the second communication control circuit (e.g., a Wi-Fi control circuit), to allow the second communication control circuit to transmit a predetermined wireless communication frame (or a protection frame) such as the null frame in a suitable situation among all situations, and therefore enhance the overall performance. Additionally, the method of the present invention and the associated apparatus can solve the problems of the related art without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless communication system according to an embodiment of the present invention.

FIG. 2 is a diagram illustrating a first example of the wireless communication system shown in FIG. 1.

FIG. 3 illustrates, in the lower half part thereof, a hybrid strategy control scheme according to an embodiment of the present invention, where a frequency-division duplexing (FDD) control scheme and a time-division duplexing (TDD) control scheme may be illustrated in the upper half part of FIG. 3 for better comprehension.

FIG. 4 illustrates the receiving (Rx) throughput with respect to the RSSI for different chips that operate based on the hybrid strategy control scheme shown in FIG. 3 according to an embodiment of the present invention.

FIG. 5 illustrates an adaptive strategy control scheme of a method for performing coexistence control based on adaptive threshold adjustment in a wireless communication device configured to operate with a first wireless communication protocol and a second wireless communication protocol according to an embodiment of the present invention.

FIG. 6 illustrates some examples of the Rx throughput with respect to the RSSI for some combinations of modes involved with the method according to an embodiment of the present invention.

FIG. 7 illustrates a first partial working flow of an adaptive strategy control procedure corresponding to the adaptive strategy control scheme shown in FIG. 5 according to an embodiment of the present invention.

FIG. 8 illustrates a second partial working flow of the adaptive strategy control procedure according to the embodiment shown in FIG. 7.

FIG. 9 illustrates an operation of monitoring the Rx throughput while the RSSI is decreasing according to an embodiment of the present invention, where the Rx throughput may decrease from a higher value to reach an optimal switching point.

FIG. 10 illustrates an operation of monitoring the Rx throughput while the RSSI is increasing according to an embodiment of the present invention, where the Rx throughput may increase from a lower value to reach the optimal switching point.

FIG. 11 illustrates the Rx throughput with respect to the RSSI for a first chip with manually fine-tuned threshold and a second chip with adaptively adjusted threshold according to an embodiment of the present invention.

FIG. 12 illustrates a main working flow of the method according to an embodiment of the present invention.

FIG. 13 is a diagram illustrating a second example of the wireless communication system shown in FIG. 1.

FIG. 14 is a diagram illustrating a third example of the wireless communication system shown in FIG. 1.

FIG. 15 is a diagram illustrating a fourth example of the wireless communication system shown in FIG. 1.

FIG. 16 is a diagram illustrating a fifth example of the wireless communication system shown in FIG. 1.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

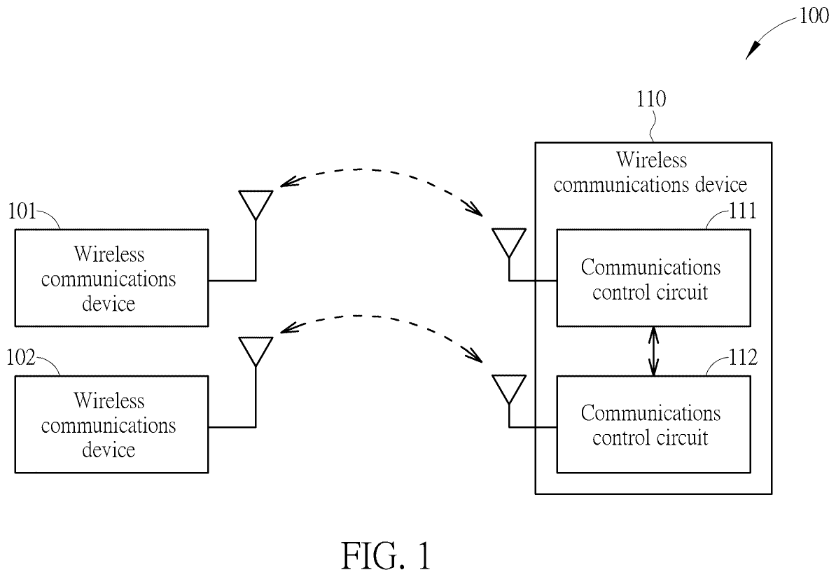

FIG. 1 is a diagram of a wireless communication system 100 according to an embodiment of the present invention. The wireless communication system 100 may comprise multiple wireless communication devices that operate according to various protocols to provide different types of communication services to a user of the wireless communication system 100, such as a wireless communication device 110 corresponding to all of the aforementioned different types of communication services, as well as at least two other wireless communication devices 101 and 102 respectively corresponding to the aforementioned different types of communication services, where the wireless communication device 110 may comprise at least two communication control circuits 111 and 112 respectively corresponding to the aforementioned different types of communication services, as well as at least one first antenna coupled to the communication control circuit 111 and at least one second antenna coupled to the communication control circuit 112, but the present invention is not limited thereto. According to some embodiments, the wireless communication device 110 may further comprise at least one processing circuit arranged to control operations of the wireless communication device 110, and the aforementioned at least one processing circuit may control the communication control circuits 111 and 112 to provide the aforementioned different types of communication services to the user.

In the architecture shown in FIG. 1, there may be multiple sub-systems respectively corresponding to the aforementioned different types of communication services. More particularly, the communication control circuit 111 may communicate with the wireless communication device 101 in compliance with a first wireless communication protocol through the aforementioned at least one first antenna, in order to provide a first wireless communication service to the user, and the communication control circuit 112 may communicate with the wireless communication device 102 in compliance with a second wireless communication protocol through the aforementioned at least one second antenna, in order to provide a second wireless communication service to the user. For example, the wireless communication devices 101 and 110 may be compatible or back-compatible to one or more versions of the Institute of Electrical and Electronics Engineers (IEEE) 802.15 standards, for providing a Bluetooth communication service to the user, and the wireless communication devices 102 and 110 may be compatible or back-compatible to one or more versions of the IEEE 802.11 standards, for providing a Wi-Fi communication service to the user, where the first wireless communication protocol may represent the IEEE 802.15 protocol and the first wireless communication service may represent the Bluetooth communication service, and the second wireless communication protocol may represent the IEEE 802.11 protocol and the second wireless communication service may represent the Wi-Fi communication service, but the present invention is not limited thereto. According to some embodiments, the architecture shown in FIG. 1, the communication control circuit count of the communication control circuits in the wireless communication device 110, the other wireless communication device count of the aforementioned at least two other wireless communication devices 101 and 102, the first wireless communication protocol and the first wireless communication service, and/or the second wireless communication protocol and the second wireless communication service may vary.

According to some embodiments, any wireless communication service among the first wireless communication service and the second wireless communication service may be implemented as a target wireless communication service among multiple wireless communication services such as a Bluetooth or Bluetooth Low Energy (BLE) communication service, a Wi-Fi communication service, a Long Term Evolution (LTE) communication service, a ZigBee communication service, etc., and the associated communication control circuit (e.g., a corresponding communication control circuit among the communication control circuits 111 and 112) and the associated other wireless communication device (e.g., a corresponding wireless communication device among the wireless communication devices 101 and 102) for providing the aforementioned any wireless communication service to the user may be implemented to conform to a target protocol among the associated protocols.

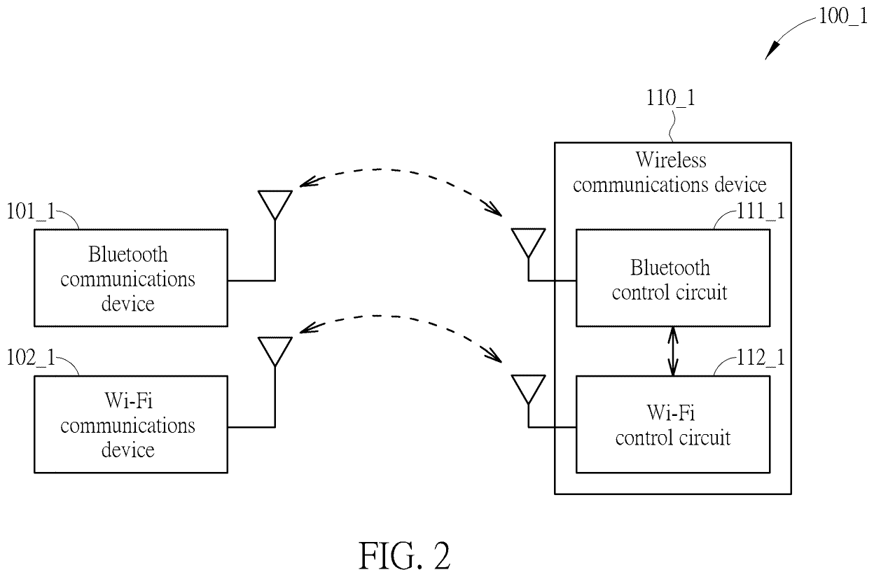

FIG. 2 illustrates a first example of the wireless communication system 100 shown in FIG. 1, such as a wireless communication system 100_1, where the wireless communication system 100_1 may comprise a Bluetooth communication device 101_1 (e.g., a BLE communication device), a Wi-Fi communication device 102_1 and a wireless communication device 110_1, and the wireless communication device 110_1 may comprise a Bluetooth control circuit 1111 (e.g., a BLE control circuit) and a Wi-Fi control circuit 112_1. The Bluetooth communication device 101_1, the Wi-Fi communication device 102_1 and the wireless communication device 1101 may be taken as examples of the wireless communication devices 101, 102 and 110, respectively, and the Bluetooth control circuit 111_1 and the Wi-Fi control circuit 112_1 may be taken as examples of the communication control circuits 111 and 112, respectively. For brevity, similar descriptions for this embodiment are not repeated in detail here.

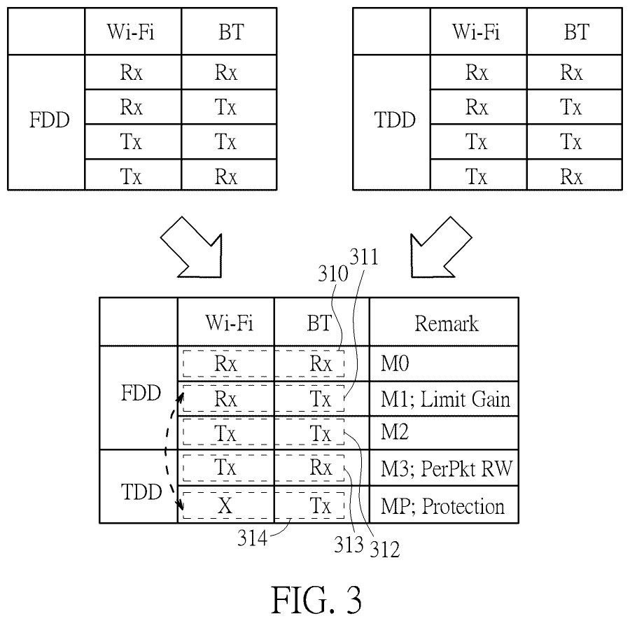

FIG. 3 illustrates, in the lower half part thereof, a hybrid strategy control scheme according to an embodiment of the present invention, where an FDD control scheme and a TDD control scheme may be illustrated in the upper half part of FIG. 3 for better comprehension. The wireless communication device 110 such as the wireless communication device 1101 may be arranged to operate according to any control scheme among the FDD control scheme, the TDD control scheme and the hybrid strategy control scheme, but the present invention is not limited thereto. According to some embodiments, the wireless communication device 110 such as the wireless communication device 1101 may be arranged to operate according to at least one control scheme such as one or a combination of the FDD control scheme, the TDD control scheme, the hybrid strategy control scheme and some other control schemes.

As shown in the upper half part of FIG. 3, the communication control circuit 111 such as the Bluetooth control circuit 111_1 and the communication control circuit 112 such as the Wi-Fi control circuit 1121 (respectively labeled “BT” and “Wi-Fi” for brevity) may perform multiple combinations of Rx and transmitting (Tx) operations (respectively labeled “Rx” and “Tx” for brevity). For example, when the aforementioned any control scheme represents the FDD control scheme, the communication control circuit 111 such as the Bluetooth control circuit 111_1 and the communication control circuit 112 such as the Wi-Fi control circuit 112_1 may provide the first wireless communication service such as the Bluetooth communication service and the second wireless communication service such as the Wi-Fi communication service to the user by using different radio frequency channels, respectively, and more particularly, perform any combination among the multiple combinations of Rx and Tx operations concurrently as shown in the upper left part of FIG. 3 via the aforementioned different radio frequency channels, respectively. As a result, transmitting Wi-Fi packets may impact the correctness of receiving Bluetooth packets, and transmitting Bluetooth packets may impact the correctness of receiving Wi-Fi packets. For another example, when the aforementioned any control scheme represents the TDD control scheme, the communication control circuit 111 such as the Bluetooth control circuit 111_1 and the communication control circuit 112 such as the Wi-Fi control circuit 112_1 may share the airtime to provide the first wireless communication service such as the Bluetooth communication service and the second wireless communication service such as the Wi-Fi communication service to the user by using different time periods such as different timing windows, respectively, and more particularly, perform any combination among the multiple combinations of Rx and Tx operations as shown in the upper right part of FIG. 3 at their own airtime (e.g., the aforementioned different timing windows), respectively. As a result, there may be insufficient time for transmitting or receiving some Wi-Fi packets and/or some Bluetooth packets.

As shown in the lower half part of FIG. 3, when the aforementioned any control scheme represents the hybrid strategy control scheme, the multiple combinations of Rx and Tx operations may comprise the combinations {310, 311, 312, 313} corresponding to multiple modes {M0, M1, M2, M3}, such as the combination 310 of Wi-Fi Rx and Bluetooth (BT) Rx operations, the combination 311 of Wi-Fi Rx and BT Tx operations, the combination 312 of Wi-Fi Tx and BT Tx operations and the combination 313 of Wi-Fi Tx and BT Rx operations, where the combinations {310, 311, 312} corresponding to the modes {M0, M1, M2} may be the same as or similar to the first three combinations (e.g., the combination of Wi-Fi Rx and BT Rx operations, the combination of Wi-Fi Rx and BT Tx operations, and the combination of Wi-Fi Tx and BT Tx operations) of the multiple combinations of Rx and Tx operations in the FDD control scheme, and the combination 313 corresponding to the mode M3 may be the same as or similar to the last combination (e.g., the combination of Wi-Fi Tx and BT Rx operations) of the multiple combinations of Rx and Tx operations in the TDD control scheme. For example, the communication control circuit 111 such as the Bluetooth control circuit 111_1 and the communication control circuit 112 such as the Wi-Fi control circuit 112_1 may provide the first wireless communication service such as the Bluetooth communication service and the second wireless communication service such as the Wi-Fi communication service to the user by selectively using the aforementioned different radio frequency channels or using the aforementioned different time periods such as the aforementioned different timing windows, and more particularly, perform most combinations of the multiple combinations of Rx and Tx operations concurrently except a certain combination as follows:
(1) the communication control circuit 111 such as the Bluetooth control circuit 111_1 and the communication control circuit 112 such as the Wi-Fi control circuit 112_1 may perform any combination among the first three combinations 310, 311 and 312 of the multiple combinations of Rx and Tx operations via the aforementioned different radio frequency channels, respectively, where the communication control circuit 112 such as the Wi-Fi control circuit 112_1 may enable a limit gain function thereof (labeled “Limit Gain” for brevity) in the mode M1 to control the gain of a low noise amplifier (LNA) on the Rx path therein to be less than or equal to a predetermined upper limit, in order to prevent saturation of the received signal of the Wi-Fi Rx operation due to the BT Tx operation; and
(2) the communication control circuit 111 such as the Bluetooth control circuit 111_1 and the communication control circuit 112 such as the Wi-Fi control circuit 112_1 may perform the remaining combination 313 of the multiple combinations of Rx and Tx operations at their own airtime (e.g., the aforementioned different timing windows), respectively, where the communication control circuit 112 such as the Wi-Fi control circuit 112_1 may enable a per packet remaining window function thereof (labeled “PerPkt RW” for brevity) in the mode M3 to perform the Wi-Fi Tx operation in a remaining window coming after a BT activity window (e.g., the window in which the BT Rx operation is performed), in order to prevent the BT Rx operation from being affected (or interfered) by the Wi-Fi Tx operation;
but the present invention is not limited thereto. For example, there may be an additional combination 314 corresponding to an additional mode MP, such as the combination 314 of Wi-Fi null and BT Tx operations. Regarding the Wi-Fi null operation (labeled “X” for brevity) in the combination 314, the communication control circuit 112 such as the Wi-Fi control circuit 112_1 may enable a protection function thereof (labeled “Protection” for brevity) in the mode MP to send a predetermined wireless communication frame such as a protection frame to the wireless communication device 102 such as the Wi-Fi communication device 102_1 to notify the wireless communication device 102 of temporarily stopping transmitting to the communication control circuit 112 such as the Wi-Fi control circuit 112_1, in order to temporarily prevent performing any Wi-Fi Tx operation and any Wi-Fi Rx operation. For example, the protection frame (or the protection frame) may be implemented as a null frame.

According to some embodiments, when there is a need, the communication control circuit 112 such as the Wi-Fi control circuit 112_1 may select a mode among the modes M1 and MP to be a selected mode according to whether at least one predetermined condition is met, in order to operate in the selected mode. For example, if the aforementioned at least one predetermined condition is met, the communication control circuit 112 such as the Wi-Fi control circuit 112_1 may select the mode MP as the selected mode, and more particularly, send the predetermined wireless communication frame (or the protection frame) such as the null frame to the wireless communication device 102 such as the Wi-Fi communication device 102_1; otherwise, the communication control circuit 112 such as the Wi-Fi control circuit 112_1 may select the mode M1 as the selected mode. In addition, the aforementioned at least one predetermined condition may be defined by at least one threshold, and whether the aforementioned at least one predetermined condition is met may be determined according to whether the aforementioned at least one threshold is reached, the aforementioned at least one threshold may comprise a signal strength threshold RSSI_TH regarding the RSSI of the communication control circuit 112 (e.g., the Wi-Fi control circuit 112_1). For example, the signal strength threshold RSSI_TH may be manually fine-tuned based on different peak physical layer (PHY) rate and Bluetooth profile combinations (e.g., various combinations of peak PHY rates and Bluetooth profiles) by one or more engineers who design the wireless communication device 110 such as the wireless communication device 110_1, but the present invention is not limited thereto. In some situations, the Wi-Fi throughput Rate vs. Range (RvR) might have a concave issue with the same protection frame threshold such as the signal strength threshold RSSI_TH. For example, the Wi-Fi RSSI may have variation with different chips. Additionally, the wireless communication device 110 such as the wireless communication device 110_1 with the same Bluetooth profile may have different Wi-Fi ratios in different environments such as on-the-air (OTA) and shielding rooms.

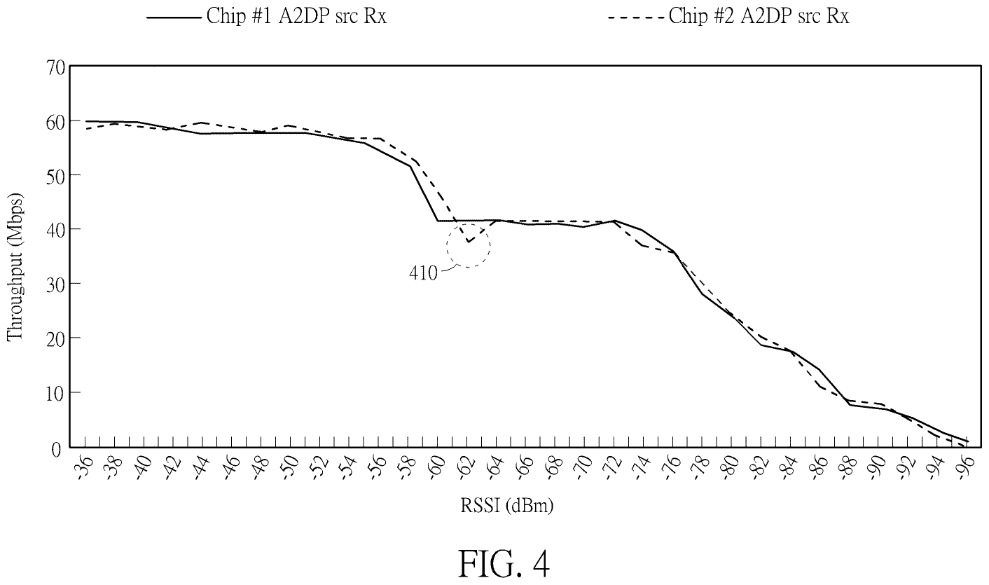

FIG. 4 illustrates the Rx throughput with respect to the RSSI for different chips (e.g., the chips #1 and #2) that operate based on the hybrid strategy control scheme shown in the lower half part of FIG. 3 according to an embodiment of the present invention, where the horizontal axis may represent the RSSI measured in unit of decibel-milliwatts (dBm) at the communication control circuit 112 (e.g., the Wi-Fi control circuit), and the vertical axis may represent the Rx throughput measured in unit of megabits per seconds (Mbps), such as the throughput corresponding to the Rx operations at the communication control circuit 112. For example, the wireless communication device 110 shown in FIG. 1 may be configured to have a set of predetermined settings such as a Wi-Fi bandwidth of 20 megahertz (MHz), an isolation of 15 decibel (dB) between the communication control circuits 111 and 112, etc., and may operate according to the hybrid strategy control scheme, but the present invention is not limited thereto. In addition, the wireless communication device 110 shown in FIG. 1 may be implemented by way of an integrated circuit (IC) or a semiconductor chip. For example, the wireless communication device 110 may be implemented as any chip among the chips #1, #2, etc., and the signal strength threshold RSSI_TH may be manually tuned for the case of a Bluetooth profile such as the Advance Audio Distribution Profile (A2DP), where the curve corresponding to the chip #1 may indicate the Wi-Fi Rx performance of the chip #1 when there is an A2DP source (labeled “Chip #1 A2DP src Rx” for brevity), and the curve corresponding to the chip #2 may indicate the Wi-Fi Rx performance of the chip #2 when there is the A2DP source (labeled “Chip #2 A2DP src Rx” for brevity). As shown in FIG. 4, the curve corresponding to the chip #2 may have a concave partial curve 410 corresponding to a throughput decrease.

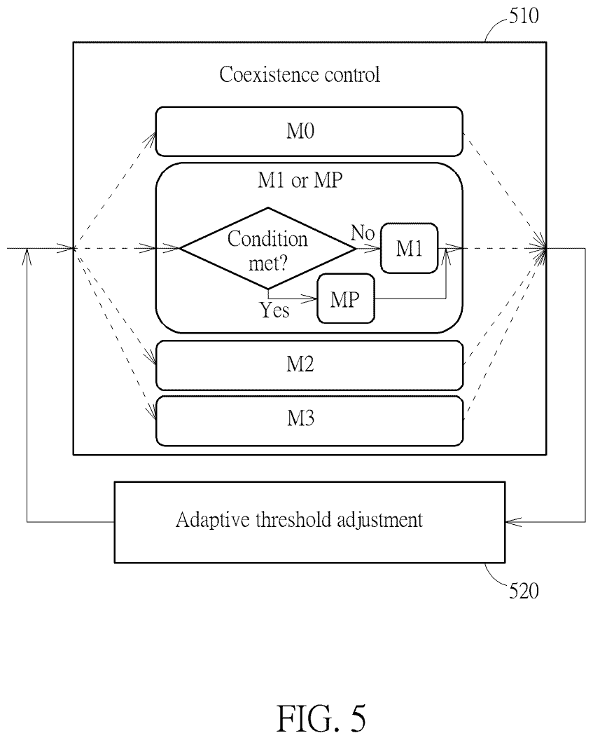

FIG. 5 illustrates an adaptive strategy control scheme of a method for performing coexistence control based on adaptive threshold adjustment in a wireless communication device (e.g., the wireless communication device 110 shown in FIG. 1) configured to operate with the first wireless communication protocol and the second wireless communication protocol according to an embodiment of the present invention. For example, the communication control circuit 111 such as the Bluetooth control circuit 111_1 and the communication control circuit 112 such as the Wi-Fi control circuit 112_1 may perform wireless communication operations (e.g., the wireless communication operations with the first wireless communication protocol and the second wireless communication protocol, respectively) concurrently, and more particularly, perform these wireless communication operations (e.g., the Rx and/or Tx operations in any combination among the combinations {310, 311, 312} shown in FIG. 3, such as the Wi-Fi Rx and BT Rx operations in the combination 310, the Wi-Fi Rx and BT Tx operations in the combination 311, and the Wi-Fi Tx and BT Tx operations in the combination 312) concurrently in an FDD manner. In addition, the communication control circuit 112 such as the Wi-Fi control circuit 112_1 may monitor a current throughput (e.g., an FDD throughput FDD_Tput in a situation where the communication control circuits 111 and 112 are arranged to perform the wireless communication operations with the first wireless communication protocol and the second wireless communication protocol concurrently in the FDD manner), compare the current throughput with a throughput threshold such as a pre-calculated throughput to determine whether the current throughput reaches the throughput threshold such as the pre-calculated throughput (e.g., a TDD throughput TDD_Tput) in order to generate at least one determination result, and adaptively determine the signal strength threshold RSSI_TH according to the aforementioned at least one determination result (e.g., the determination result indicating whether the current throughput reaches the throughput threshold such as the pre-calculated throughput). Additionally, the communication control circuit 112 such as the Wi-Fi control circuit 112_1 may compare the RSSI (e.g., the current RSSI Cur_RSSI) of the communication control circuit 112, such as the RSSI (e.g., the current RSSI Cur_RSSI) in the communication using the second wireless communication protocol, with the signal strength threshold RSSI_TH to generate at least one comparison result, and selectively send the predetermined wireless communication frame (or the protection frame) such as the null frame to the wireless communication device 102 such as the Wi-Fi communication device 102_1 according to the aforementioned at least one comparison result (e.g., the comparison result indicating whether the current RSSI Cur_RSSI is less than the signal strength threshold RSSI_TH), in order to temporarily avoid communication using the second wireless communication protocol (e.g., the communication with the wireless communication device 102 such as the Wi-Fi communication device 102_1). For example, when the current throughput is less than the throughput threshold such as the pre-calculated throughput, the communication control circuit 112 such as the Wi-Fi control circuit 1121 may compare the RSSI (e.g., the current RSSI Cur_RSSI), in communication using the second wireless communication protocol, with the signal strength threshold RSSI_TH to generate the aforementioned at least one comparison result, for performing the subsequent operations according to the aforementioned at least one comparison result.

As shown in FIG. 5, the communication control circuit 111 such as the Bluetooth control circuit 111_1 and the communication control circuit 112 such as the Wi-Fi control circuit 112_1 may perform the coexistence control 510 based on the adaptive threshold adjustment 520, and more particularly, perform the associated operations of the combinations {310, 311, 312, 313, 314} in the modes M0, M1, M2, M3 and MP, and perform the adaptive threshold adjustment 520 to adaptively adjust the signal strength threshold RSSI_TH, for guaranteeing the correctness of the determination of whether the aforementioned predetermined condition is met, in order to properly switch among the modes M1 and MP and therefore prevent the concave issue mentioned above.

Regarding performing the wireless communication operations with the first wireless communication protocol and the second wireless communication protocol concurrently, some implementation details may be further described as follows. The Rx operations and the Tx operations among all wireless communication operations of the modes M0, M1, M2, M3 and MP may represent packet reception operations and packet transmission operations, respectively. The communication control circuit 111 such as the Bluetooth control circuit 111_1 and the communication control circuit 112 such as the Wi-Fi control circuit 1121 may perform the wireless communication operations with the first wireless communication protocol and the second wireless communication protocol concurrently in an FDD manner, and more particularly, perform packet transmission and packet reception via different radio frequency channels. In the communication using the first wireless communication protocol, the communication control circuit 111 (e.g., the Bluetooth control circuit 111_1) may transmit a first packet such as the packet PKT_{BT_Tx} to the wireless communication device 101 (e.g., the Bluetooth communication device 101_1) and receive a third packet such as the packet PKT_{BT_Rx} from the wireless communication device 101 via a first radio frequency channel such as the radio frequency channel CH_{BT}, and in the communication using the second wireless communication protocol, the communication control circuit 112 (e.g., the Wi-Fi control circuit 112_1) may transmit a second packet such as the packet PKT_{WF_Tx} to the wireless communication device 102 (e.g., the Wi-Fi communication device 102_1) and receive a fourth packet such as the packet PKT_{WF_Rx} from the wireless communication device 102 via a second radio frequency channel such as the radio frequency channel CH_{WF}. For example, the first radio frequency channel such as the radio frequency channel CH_{BT} may represent a channel CH among multiple channels {CH} of a first predetermined radio frequency band (e.g., the 2.4 GHz band), and the second radio frequency channel such as the radio frequency channel CH_{WF} may represent another channel CH among the multiple channels {CH} of the first predetermined radio frequency band, but the present invention is not limited thereto.

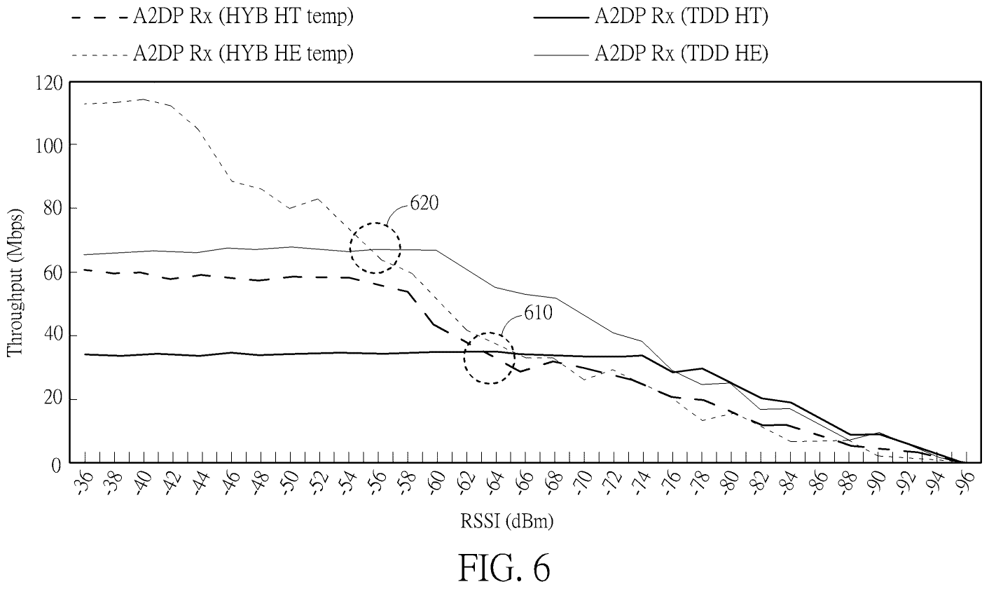

FIG. 6 illustrates some examples of the Rx throughput with respect to the RSSI for some combinations of modes involved with the method according to an embodiment of the present invention, where the horizontal axis may represent the RSSI measured in unit of dBm at the communication control circuit 112 (e.g., the Wi-Fi control circuit), and the vertical axis may represent the Rx throughput measured in unit of Mbps, such as the throughput corresponding to the Rx operations at the communication control circuit 112. As the communication control circuit 111 (e.g., the Bluetooth control circuit 111_1) may not transmit packets all the time, and as the communication control circuit 112 (e.g., the Wi-Fi control circuit 112_1) may send the predetermined wireless communication frame (or the protection frame) such as the null frame regarding the protection function to the wireless communication device 102 (e.g., the Wi-Fi communication device 102_1) in the mode MP, in order to notify the wireless communication device 102 of temporarily stopping transmitting to the communication control circuit 112 (as if the communication control circuit 112 is sleeping) rather than permanently stopping transmitting to the communication control circuit 112, the communication control circuit 112 may temporarily avoid the communication using the second wireless communication protocol for a certain length of time when there is a need, and resume the communication using the second wireless communication protocol afterward to receive packets from the wireless communication device 102.

The wireless communication device 110 (or the communication control circuit 112 such as the Wi-Fi control circuit 112_1 therein) may decide the protection frame threshold such as the signal strength threshold RSSI_TH dynamically, and more particularly, update the signal strength threshold RSSI_TH when the current throughput (e.g., the FDD throughput FDD_Tput, which may also be referred to as the hybrid throughput, since the FDD throughput FDD_Tput may be a throughput corresponding to the mode M1 in which the limit gain function is enabled as illustrated with the hybrid strategy control scheme shown in the lower half part of FIG. 3) is lower than the pre-calculated throughput (e.g., the TDD throughput TDD_Tput). For example, the FDD throughput FDD_Tput such as the hybrid throughput may be calculated by the current PHY rate and the driver information, and the TDD throughput TDD_Tput may be calculated by the Wi-Fi ratio and the peak PHY rate. For better comprehension, assume that the wireless communication device 110 (or the communication control circuit 112 such as the Wi-Fi control circuit 112_1 therein) may operate in one the modes M1 and MP in combination with one of multiple predetermined wireless communication mode such as the high throughput (HT) mode and the high efficient (HE) mode, but the present invention is not limited thereto. In some examples, in addition to the HT mode and the HE mode, the multiple predetermined wireless communication modes may further comprise an extremely high throughput (HT) mode.

Regarding the HT mode, a first curve corresponding to the mode M1 for performing the Wi-Fi Rx and BT Tx operations concurrently in the hybrid strategy control scheme may indicate the Wi-Fi Rx performance of the mode M1 when the Bluetooth profile is the A2DP (labeled “A2DP Rx (HYB HT temp)” for brevity), and a second curve corresponding to the mode MP for performing the Wi-Fi null and BT Tx operations in the TDD manner may indicate the Wi-Fi Rx performance of the mode MP when the Bluetooth profile is the A2DP (labeled “A2DP Rx (TDD HT)” for brevity). At the intersection of the respective partial curves 610 of the first curve and the second curve as shown in FIG. 6, there is an optimal switching point for switching among the modes M1 and MP. Assume that the communication control circuit 112 such as the Wi-Fi control circuit 112_1 may be operating in the mode M1, and the RSSI (e.g., the current RSSI Cur_RSSI) of the communication control circuit 112 may decrease from a higher value. As the Rx throughput indicated by the first curve is higher than the Rx throughput indicated by the second curve at the left hand side of the optimal switching point indicated by the intersection of the partial curves 610, the communication control circuit 112 such as the Wi-Fi control circuit 1121 may keep staying in the mode M1, having no need to switch from the mode M1 to the mode MP. When the RSSI (e.g., the current RSSI Cur_RSSI) decreases from the higher value to reach the optimal switching point indicated by the intersection of the partial curves 610, the communication control circuit 112 such as the Wi-Fi control circuit 112_1 may switch from the mode M1 to the mode MP, since the Rx throughput indicated by the first curve will become lower than the Rx throughput indicated by the second curve at the right hand side of the optimal switching point indicated by the intersection of the partial curves 610.

Regarding the HE mode, a third curve corresponding to the mode M1 for performing the Wi-Fi Rx and BT Tx operations concurrently in the hybrid strategy control scheme may indicate the Wi-Fi Rx performance of the mode M1 when the Bluetooth profile is the A2DP (labeled “A2DP Rx (HYB HE temp)” for brevity), and a fourth curve corresponding to the mode MP for performing the Wi-Fi null and BT Tx operations in the TDD manner may indicate the Wi-Fi Rx performance of the mode MP when the Bluetooth profile is the A2DP (labeled “A2DP Rx (TDD HE)” for brevity). At the intersection of the respective partial curves 620 of the third curve and the fourth curve as shown in FIG. 6, there is an optimal switching point for switching among the modes M1 and MP. Assume that the communication control circuit 112 such as the Wi-Fi control circuit 112_1 may be operating in the mode M1, and the RSSI (e.g., the current RSSI Cur_RSSI) of the communication control circuit 112 may decrease from a higher value. As the Rx throughput indicated by the third curve is higher than the Rx throughput indicated by the fourth curve at the left hand side of the optimal switching point indicated by the intersection of the partial curves 620, the communication control circuit 112 such as the Wi-Fi control circuit 1121 may keep staying in the mode M1, having no need to switch from the mode M1 to the mode MP. When the RSSI (e.g., the current RSSI Cur_RSSI) decreases from the higher value to reach the optimal switching point indicated by the intersection of the partial curves 620, the communication control circuit 112 such as the Wi-Fi control circuit 112_1 may switch from the mode M1 to the mode MP, since the Rx throughput indicated by the third curve will become lower than the Rx throughput indicated by the fourth curve at the right hand side of the optimal switching point indicated by the intersection of the partial curves 620.

According to some embodiments, regarding selectively sending the predetermined wireless communication frame (or the protection frame) such as the null frame according to the aforementioned at least one comparison result, the communication control circuit 112 (e.g., the Wi-Fi control circuit 112_1) may be arranged to send the predetermined wireless communication frame such as the null frame to the wireless communication device 102 (e.g., the Wi-Fi communication device 102_1) in response to the aforementioned at least one predetermined condition being met, where the aforementioned at least one predetermined condition may comprise a first predetermined condition, and the first predetermined condition may represent that the RSSI (e.g., the current RSSI Cur_RSSI) of the communication control circuit 112, such as the RSSI (e.g., the current RSSI Cur_RSSI) in the communication using the second wireless communication protocol, is less than the signal strength threshold RSSI_TH, but the present invention is not limited thereto. For example, the aforementioned at least one predetermined condition may further comprise a second predetermined condition, where the second predetermined condition may represent that transmission duty Tx_duty (e.g., a Bluetooth transmission duty) of the communication control circuit 111 (e.g., the Bluetooth control circuit 111_1) reaches a first predetermined threshold Tx_duty_TH (e.g., a Bluetooth Tx duty threshold). For brevity, similar descriptions for these embodiments are not repeated in detail here.

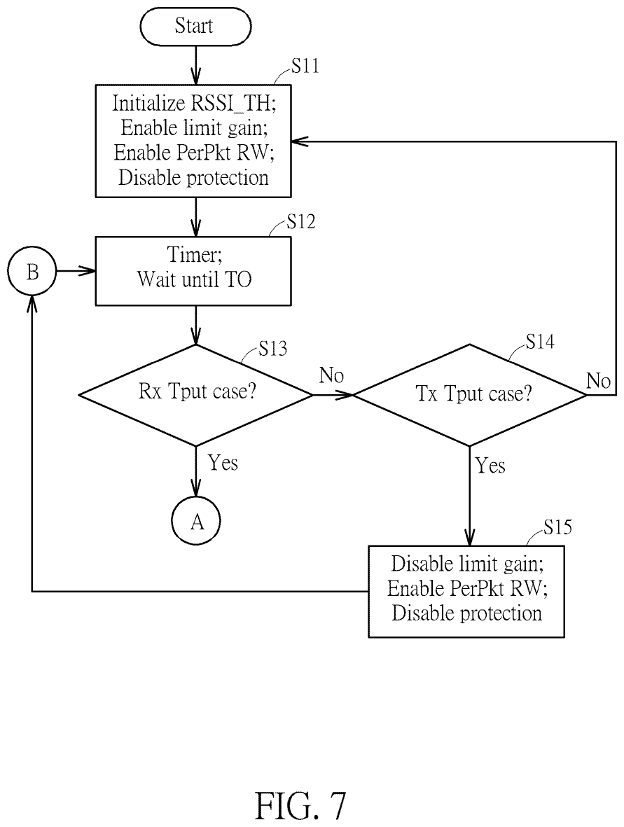

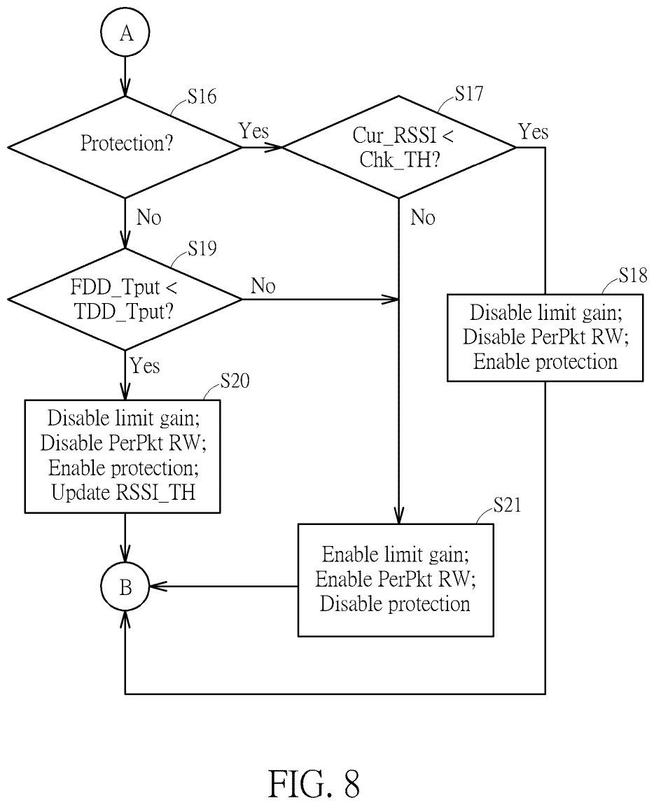

FIG. 7 and FIG. 8 respectively illustrate a first partial working flow and a second partial working flow of an adaptive strategy control procedure (e.g., the control procedure comprising the operations of Steps S11 to S21) corresponding to the adaptive strategy control scheme shown in FIG. 5 according to an embodiment of the present invention. For better comprehension, the nodes A and B may be illustrated for indicating that the first partial working flow (or some steps thereof) shown in FIG. 7 and the second partial working flow (or some steps thereof) shown in FIG. 8 may be connected to each other, but the present invention is not limited thereto.

For example, the wireless communication device 110 (or the communication control circuit 112 such as the Wi-Fi control circuit 112_1 therein) may operate according to the adaptive strategy control procedure as shown in FIG. 7 and FIG. 8. In addition, the wireless communication device 110 may utilize the communication control circuit 112 such as the Wi-Fi control circuit 112_1 to configure at least one function related to the communication using the second wireless communication protocol (or the function(s) of the communication control circuit 112), such as the limit gain function, the per packet remaining window function and the protection function (respectively labeled “limit gain”, “PerPkt RW” and “protection” in FIG. 7 and FIG. 8 for brevity), in Step S11, in order to start performing the coexistence control on the communication control circuit 111 and 112, where configuring the aforementioned at least one function may comprise setting an enabling or disabling state of any function among the aforementioned at least one function, but the present invention is not limited thereto. As illustrated with the working flow shown in FIG. 7 and FIG. 8, the wireless communication device 110 may utilize the communication control circuit 112 such as the Wi-Fi control circuit 112_1 to re-configure the aforementioned at least one function in any step among Steps S15, S18, S20 and S21, in order to continue performing the coexistence control on the communication control circuit 111 and 112, where re-configuring the aforementioned at least one function may comprise updating the aforementioned enabling or disabling state of the aforementioned any function among the aforementioned at least one function. Additionally, when Step S11 is re-entered, the wireless communication device 110 may utilize the communication control circuit 112 such as the Wi-Fi control circuit 112_1 to re-configure the aforementioned at least one function in Step S11, in order to continue performing the coexistence control on the communication control circuit 111 and 112, but the present invention is not limited thereto.

In Step S11, the wireless communication device 110 may utilize the communication control circuit 112 such as the Wi-Fi control circuit 112_1 to initialize the protection frame threshold such as the signal strength threshold RSSI_TH, enable the limit gain function, enable the per packet remaining window function and disable the protection function, where initializing the protection frame threshold such as the signal strength threshold RSSI_TH may comprise setting the initial value of the signal strength threshold RSSI_TH. For example, the initial value of the signal strength threshold RSSI_TH regarding the HT mode may be equal to −61 (dBm), and the initial value of the signal strength threshold RSSI_TH regarding the HE mode may be equal to −54 (dBm), the initial value of the signal strength threshold RSSI_TH regarding the HT mode may be equal to a certain value TBD (still in unit of dBm), but the present invention is not limited thereto. In some examples, the initial value of the signal strength threshold RSSI_TH may vary.

In Step S12, the wireless communication device 110 may utilize the communication control circuit 112 such as the Wi-Fi control circuit 112_1 to set a timer for controlling timing of repeatedly executing at least one partial working flow within the working flow of the adaptive strategy control procedure, and more particularly, wait until timeout of the timer (labeled “TO” in FIG. 7 for brevity), where setting the timer may comprise setting a predetermined waiting time T_wait of the timer, and the timeout of the timer may represent that the predetermined waiting time T_wait expires. For example, the predetermined waiting time T_wait may be equal to 1000 milliseconds (ms), but the present invention is not limited thereto. In some examples, the predetermined waiting time T_wait may vary, and more particularly, may be equal to any value among some other values. After the operation of Step S12 is completed, the wireless communication device 110 may utilize the communication control circuit 112 such as the Wi-Fi control circuit 112_1 to start classifying the current communication behavior of the communication control circuit 112 into one of multiple predetermined communication behavior cases, such as any case among the Rx throughput case and the Tx throughput case (respectively labeled “Rx Tput case” and “Tx Tput case” in FIG. 7 for brevity) or the idle case corresponding to the partial working flow from Step S14 to Step S11.

In Step S13, the wireless communication device 110 may utilize the communication control circuit 112 such as the Wi-Fi control circuit 112_1 to determine whether the current communication behavior of the communication control circuit 112 belongs to (or should be classified into) the Rx throughput case. If Yes, Step S16 shown in FIG. 8 is entered, where Step S16 may be connected to Step S13 through the node A; if No, Step S14 is entered. More particularly, the communication control circuit 112 such as the Wi-Fi control circuit 112_1 may determine whether the Rx data ratio Ratio_Rx (e.g., the Wi-Fi Rx data ratio) of the communication control circuit 112 reaches a predetermined Rx data ratio threshold Ratio_Rx_TH, in order to determine whether the current communication behavior of the communication control circuit 112 belongs to the Rx throughput case. If the Rx data ratio Ratio_Rx reaches the predetermined Rx data ratio threshold Ratio_Rx_TH (e.g., Ratio_Rx≥Ratio_Rx_TH), the communication control circuit 112 such as the Wi-Fi control circuit 1121 may determine that the current communication behavior of the communication control circuit 112 belongs to the Rx throughput case, so Step S16 is entered; otherwise, the communication control circuit 112 such as the Wi-Fi control circuit 112_1 may determine that the current communication behavior of the communication control circuit 112 does not belong to the Rx throughput case, so Step S14 is entered. For example, the predetermined Rx data ratio threshold Ratio_Rx_TH may be equal to 30%, but the present invention is not limited thereto. According to some embodiments, the predetermined Rx data ratio threshold Ratio_Rx_TH may vary. For example, the predetermined Rx data ratio threshold Ratio_Rx_TH may be equal to any value among some other values.

In Step S14, the wireless communication device 110 may utilize the communication control circuit 112 such as the Wi-Fi control circuit 112_1 to determine whether the current communication behavior of the communication control circuit 112 belongs to (or should be classified into) the Tx throughput case. If Yes, Step S15 is entered; if No, Step S11 is entered. More particularly, the communication control circuit 112 such as the Wi-Fi control circuit 112_1 may determine whether the Tx throughput Tx_Tput (e.g., the Wi-Fi Tx throughput) of the communication control circuit 112 reaches a predetermined Tx throughput threshold Tx_Tput_TH, in order to determine whether the current communication behavior of the communication control circuit 112 belongs to the Tx throughput case. If the Tx throughput Tx_Tput reaches the predetermined Tx throughput threshold Tx_Tput_TH (e.g., Tx_Tput≥Tx_Tput_TH), the communication control circuit 112 such as the Wi-Fi control circuit 112_1 may determine that the current communication behavior of the communication control circuit 112 belongs to the Tx throughput case, so Step S15 is entered; otherwise, the communication control circuit 112 such as the Wi-Fi control circuit 112_1 may determine that the current communication behavior of the communication control circuit 112 does not belong to the Tx throughput case, so Step S11 is entered. For example, the predetermined Tx throughput threshold Tx_Tput_TH may be equal to 2 Mbps, but the present invention is not limited thereto. According to some embodiments, the predetermined Tx throughput threshold Tx_Tput_TH may vary. For example, the predetermined Tx throughput threshold Tx_Tput_TH may be equal to any value among some other values.

In Step S15, in response to determining that the current communication behavior of the communication control circuit 112 belongs to the Tx throughput case (e.g., Tx_Tput≥Tx_Tput_TH), the wireless communication device 110 may utilize the communication control circuit 112 such as the Wi-Fi control circuit 112_1 to disable the limit gain function, enable the per packet remaining window function and disable the protection function.

In Step S16, the wireless communication device 110 may utilize the communication control circuit 112 such as the Wi-Fi control circuit 112_1 to determine whether the current communication behavior of the communication control circuit 112 belongs to an exist-protection case (labeled “Protection” for brevity) such as the case suitable for enabling the protection function. If Yes, Step S17 is entered; if No, Step S19 is entered. For example, the wireless communication device 110 may utilize the communication control circuit 112 such as the Wi-Fi control circuit 112_1 to compare the current RSSI Cur_RSSI of the communication control circuit 112, such as the current RSSI Cur_RSSI in the communication using the second wireless communication protocol, with the signal strength threshold RSSI_TH plus a predetermined margin RSSI_TH_margin1 regarding the signal strength threshold RSSI_TH (i.e., the summation (RSSI_TH+RSSI_TH_margin1) thereof) to generate any comparison result among the aforementioned at least one comparison result, in order to determine whether the current communication behavior of the communication control circuit 112 belongs to the exist-protection case, where the aforementioned at least one comparison result may comprise multiple comparison results respectively corresponding to different times of execution of Step S16. In addition, the predetermined margin RSSI_TH_margin1 may be equal to 3 (dBm), but the present invention is not limited thereto. According to some embodiments, the predetermined margin RSSI_TH_margin1 may vary. For example, the predetermined margin RSSI_TH_margin1 may be equal to any value among some other values.

As illustrated with the working flow shown in FIG. 7 and FIG. 8, the operation of Step S16 (e.g., the operation of comparing the current RSSI Cur_RSSI with the signal strength threshold RSSI_TH plus the predetermined margin RSSI_TH_margin1) may be performed multiple times to generate the multiple comparison results, respectively, where the multiple comparison results may comprise a first comparison result indicating that the current RSSI Cur_RSSI reaches (e.g., is greater than or equal to) the signal strength threshold RSSI_TH plus the predetermined margin RSSI_TH_margin1, and a second comparison result indicating that the current RSSI Cur_RSSI is less than the signal strength threshold RSSI_TH plus the predetermined margin RSSI_TH_margin1. For example, in response to the first comparison result (e.g., Cur_RSSI≥(RSSI_TH+RSSI_TH_margin1)), the communication control circuit 112 such as the Wi-Fi control circuit 1121 may determine that the current communication behavior of the communication control circuit 112 does not belong to the exist-protection case, so Step S19 is entered. For another example, in response to the second comparison result (e.g., Cur_RSSI<(RSSI_TH+RSSI_TH_margin1)), the communication control circuit 112 such as the Wi-Fi control circuit 112_1 may determine that the current communication behavior of the communication control circuit 112 belongs to the exist-protection case, so Step S17 is entered.

In Step S17, in response to the second comparison result (e.g., Cur_RSSI<(RSSI_TH+RSSI_TH_margin1)), the wireless communication device 110 may utilize the communication control circuit 112 such as the Wi-Fi control circuit 112_1 to compare the current RSSI Cur_RSSI in the communication using the second wireless communication protocol with a checking-related signal strength threshold Chk_TH, and more particularly, determine whether the current RSSI Cur_RSSI is less than the checking-related signal strength threshold Chk_TH, in order to re-configure the aforementioned at least one function, where the checking-related signal strength threshold Chk_TH may be equal to the signal strength threshold RSSI_TH plus a predetermined margin RSSI_TH_margin2 (i.e., the summation (RSSI_TH+RSSI_TH_margin2) thereof). If Yes (e.g., Cur_RSSI<Chk_TH), Step S18 is entered; if No (e.g., Cur_RSSI≥Chk_TH), Step S21 is entered. For example, the predetermined margin RSSI_TH_margin2 may be equal to 3 (dBm), but the present invention is not limited thereto. According to some embodiments, the predetermined margin RSSI_TH_margin2 may vary. For example, the predetermined margin RSSI_TH_margin2 may be equal to any value among some other values.

In Step S18, in response to determining that the current RSSI Cur_RSSI does not reach the checking-related signal strength threshold Chk_TH (e.g., Cur_RSSI<Chk_TH), the wireless communication device 110 may utilize the communication control circuit 112 such as the Wi-Fi control circuit 112_1 to disable the limit gain function, disable the per packet remaining window function and enable the protection function.

In Step S19, in response to the first comparison result (e.g., Cur_RSSI≥(RSSI_TH+RSSI_TH_margin1)), the wireless communication device 110 may utilize the communication control circuit 112 such as the Wi-Fi control circuit 112_1 to determine whether the current throughput such as the FDD throughput FDD_Tput reaches (e.g., is greater than or equal to) the pre-calculated throughput such as the TDD throughput TDD_Tput, to generate any determination result among the aforementioned at least one determination result. For better comprehension, the operation of comparing the current throughput such as the FDD throughput FDD_Tput with the aforementioned throughput threshold (e.g., the pre-calculated throughput such as the TDD throughput TDD_Tput) may be performed at least one time to determine whether the current throughput reaches this throughput threshold to generate the aforementioned at least one determination result, where the aforementioned at least one determination result may comprise multiple determination results respectively corresponding to different times of execution of Step S19.

As illustrated with the working flow shown in FIG. 7 and FIG. 8, the operation of Step S19 (e.g., the operation of determining whether the current throughput such as the FDD throughput FDD_Tput reaches the pre-calculated throughput such as the TDD throughput TDD_Tput) may be performed multiple times to generate the multiple determination results, respectively, where the multiple determination results may comprise a first determination result and a second determination result. The first determination result may indicate that the current throughput such as the FDD throughput FDD_Tput does not reach the aforementioned throughput threshold (e.g., the pre-calculated throughput such as the TDD throughput TDD_Tput), and the second determination result may indicate that the current throughput such as the FDD throughput FDD_Tput reaches the aforementioned throughput threshold (e.g., the pre-calculated throughput such as the TDD throughput TDD_Tput). For example, in response to the first determination result (e.g., FDD_Tput<TDD_Tput), the wireless communication device 110 (or the communication control circuit 112 such as the Wi-Fi control circuit 112_1) may execute Step S20 to update the signal strength threshold RSSI_TH. For another example, in response to the second determination result (e.g., FDD_Tput≥TDD_Tput), the wireless communication device 110 (or the communication control circuit 112 such as the Wi-Fi control circuit 112_1) may execute Step S21 to prevent updating the signal strength threshold RSSI_TH at this moment. For yet another example, in response to the second determination result (e.g., FDD_Tput>TDD_Tput), the wireless communication device 110 (or the communication control circuit 112 such as the Wi-Fi control circuit 112_1) may execute Step S21 to prevent updating the signal strength threshold RSSI_TH at this moment.

In Step S20, in response to the first determination result (e.g., FDD_Tput<TDD_Tput), the wireless communication device 110 may utilize the communication control circuit 112 such as the Wi-Fi control circuit 112_1 to disable the limit gain function, disable the per packet remaining window function and enable the protection function, and update the aforementioned protection frame threshold such as the signal strength threshold RSSI_TH. For example, the wireless communication device 110 (or the communication control circuit 112 such as the Wi-Fi control circuit 112_1) may update the protection frame threshold such as the signal strength threshold RSSI_TH according to the latest value of the current RSSI Cur_RSSI (e.g., the value of the current RSSI Cur_RSSI at the time point when Step S20 is executed) in the communication using the second wireless communication protocol.

In Step S21, in response to determining that the current RSSI Cur_RSSI reaches the checking-related signal strength threshold Chk_TH (e.g., Cur_RSSI≥Chk_TH) in Step S17 or in response to the second determination result (e.g., FDD_Tput≥TDD_Tput) of Step S19, the wireless communication device 110 may utilize the communication control circuit 112 such as the Wi-Fi control circuit 112_1 to enable the limit gain function, enable the per packet remaining window function and disable the protection function.

As illustrated with the partial working flows starting from Step S19 and respectively reaching Steps S20 and S21 as shown in FIG. 8, the communication control circuit 112 such as the Wi-Fi control circuit 1121 may be arranged to selectively update the signal strength threshold RSSI_TH in response to the first determination result (e.g., FDD_Tput<TDD_Tput) or prevent updating the signal strength threshold RSSI_TH in response to the second determination result (e.g., FDD_Tput>TDD_Tput).

For better comprehension, the adaptive strategy control procedure may be illustrated with the working flow shown in FIG. 7 and FIG. 8, but the present invention is not limited thereto. According to some embodiments, one or more steps may be added, deleted, or changed in the working flow shown in FIG. 7 and FIG. 8. For example, the adaptive strategy control procedure may further comprise calculating the aforementioned throughput threshold (e.g., the pre-calculated throughput such as the TDD throughput TDD_Tput) according to at least one factor related to communication using the second wireless communication protocol (or the factor(s) regarding the communication control circuit 112). More particularly, the aforementioned at least one factor may comprise one or a combination of a peak throughput Peak_Tput (e.g., the peak PHY rate) based on a predetermined wireless communication mode (e.g., any mode among the EHT mode, the HE mode and the HT mode), and an airtime sharing ratio Ratio_airtime_sharing (e.g., the Rx data ratio Ratio_Rx such as the Wi-Fi Rx data ratio or the Wi-Fi ratio) of the communication control circuit 112 (e.g., the Wi-Fi control circuit 112_1) that is based on at least one predetermined profile (e.g., at least one Bluetooth profile such as the A2DP and/or the Human Interface Device (HID) profile) of at least one communication control circuit (e.g., the Bluetooth control circuit 111_1) among the communication control circuits 111 and 112 (e.g., the Bluetooth control circuit 111_1 and the Wi-Fi control circuit 112_1), such as the predetermined profile(s) of the communication using the first wireless communication protocol and/or the communication using the second wireless communication protocol. For example, TDD_Tput=Peak_Tput*Ratio_airtime_sharing*N_coeff, where “N_coeff” may represent a predetermined coefficient such as 1.2, but the present invention is not limited thereto. In some examples, the predetermined coefficient N_coeff may vary, and more particularly, may be equal to any value among some other values. For brevity, similar descriptions for these embodiments are not repeated in detail here.

According to some embodiments, the wireless communication device 110 (or the communication control circuit 112 such as the Wi-Fi control circuit 112_1 therein) may determine the airtime sharing ratio Ratio_airtime_sharing (e.g., the Rx data ratio Ratio_Rx such as the Wi-Fi Rx data ratio or the Wi-Fi ratio) according to a selected profile among the aforementioned at least one predetermined profile, and the aforementioned at least one predetermined profile may comprise the aforementioned at least one Bluetooth profile such as the A2DP, the HID profile, etc., where the airtime sharing ratio Ratio_airtime_sharing may vary with respect to the selected profile. For example, a first Bluetooth profile among the aforementioned at least one Bluetooth profile may correspond to a case that there is the A2DP source, and a second Bluetooth profile among the aforementioned at least one Bluetooth profile may correspond to a case that there are the A2DP source and a HID, etc., but the present invention is not limited thereto. In some examples, the wireless communication device 110 (or the communication control circuit 112 such as the Wi-Fi control circuit 112_1 therein) may determine the airtime sharing ratio Ratio_airtime_sharing (e.g., the Rx data ratio Ratio_Rx such as the Wi-Fi Rx data ratio or the Wi-Fi ratio) according to the selected profile among the aforementioned at least one predetermined profile as well as a selected A2DP coder-decoder (Codec) among multiple types of A2DP Codecs such as Sub-band Codec (SBC), Lossless Digital Audio Codec (LDAC), etc., where the airtime sharing ratio Ratio_airtime_sharing may vary with respect to the selected profile, and may vary with respect to the selected A2DP Codec. For brevity, similar descriptions for these embodiments are not repeated in detail here.

According to some embodiments, re-entering Step S11 from Step S14 may be regarded as entering a new round (e.g., the next round) among multiple rounds of processing in the adaptive strategy control procedure. When Step S11 is re-entered, the wireless communication device 110 may utilize the communication control circuit 112 such as the Wi-Fi control circuit 112_1 to configure the aforementioned at least one function in Step S11 for the new round (e.g., the next round), in order to re-start performing the coexistence control on the communication control circuit 111 and 112. For brevity, similar descriptions for these embodiments are not repeated in detail here.

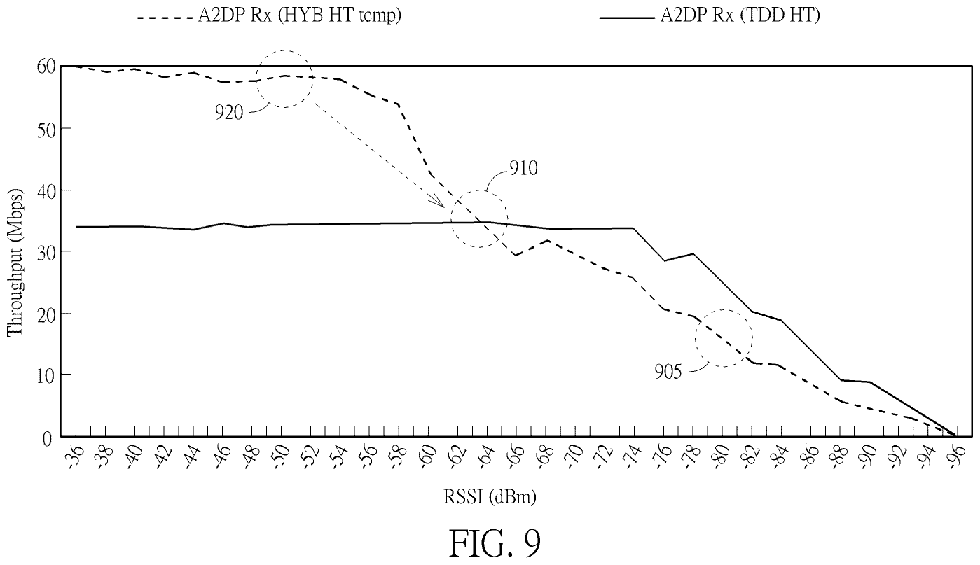

FIG. 9 illustrates an operation of monitoring the Rx throughput (e.g., the current throughput such as the FDD throughput FDD_Tput) while the RSSI (e.g., the current RSSI Cur_RSSI) is decreasing according to an embodiment of the present invention, where the Rx throughput may decrease from a higher value to reach an optimal switching point. For better comprehension, regarding the HT mode, a fifth curve corresponding to the mode M1 for performing the Wi-Fi Rx and BT Tx operations concurrently in the hybrid strategy control scheme may indicate the Wi-Fi Rx performance of the mode M1 when the Bluetooth profile is the A2DP (labeled “A2DP Rx (HYB HT temp)” for brevity), and a sixth curve corresponding to the mode MP for performing the Wi-Fi null and BT Tx operations in the TDD manner may indicate the Wi-Fi Rx performance of the mode MP when the Bluetooth profile is the A2DP (labeled “A2DP Rx (TDD HT)” for brevity). At the intersection of the respective partial curves 910 of the fifth curve and the sixth curve as shown in FIG. 9, there is the optimal switching point for switching among the modes M1 and MP. For example, the fifth curve and the sixth curve may be equal to the first curve and the second curve of the embodiment shown in FIG. 6, and the partial curves 910 may represent the partial curves 610 shown in FIG. 6, but the present invention is not limited thereto. According to some embodiments, the fifth curve and the sixth curve may vary. In addition, assume that the correct value of the signal strength threshold RSSI_TH may be equal to −64 (dBm), but the present invention is not limited thereto. According to some embodiments, the correct value of the signal strength threshold RSSI_TH may vary, and more particularly, may be equal to any value among some other values. Additionally, assuming that the initial value of the signal strength threshold RSSI_TH has been erroneously set as −50 (dBm), and the RSSI (e.g., the current RSSI Cur_RSSI) is decreasing, from high to low. Even when the RSSI (e.g., the current RSSI Cur_RSSI) is less than −50 (dBm) (which may make the determination result of Step S16 be “Yes” to proceed rightward to Step S17 as shown in FIG. 8), since FDD_Tput>TDD_Tput (which may make the determination result of Step S19 be “No” to proceed to Step S21 as shown in FIG. 8), it will not trigger enabling the protection function and sending the protection frame from the communication control circuit 112 (e.g., the Wi-Fi control circuit 112_1) to the wireless communication device 102 (e.g., the Wi-Fi communication device 102_1). In a situation where the RSSI (e.g., the current RSSI Cur_RSSI) decreases until the optimal switching point indicated by the intersection of the partial curves 910 is reached, for example, when FDD_Tput<TDD_Tput, it will trigger enabling the protection function and sending the protection frame from the communication control circuit 112 (e.g., the Wi-Fi control circuit 112_1) to the wireless communication device 102 (e.g., the Wi-Fi communication device 102_1) as well as updating the signal strength threshold RSSI_TH to be equal to −64 (dBm). For brevity, similar descriptions for this embodiment are not repeated in detail here.

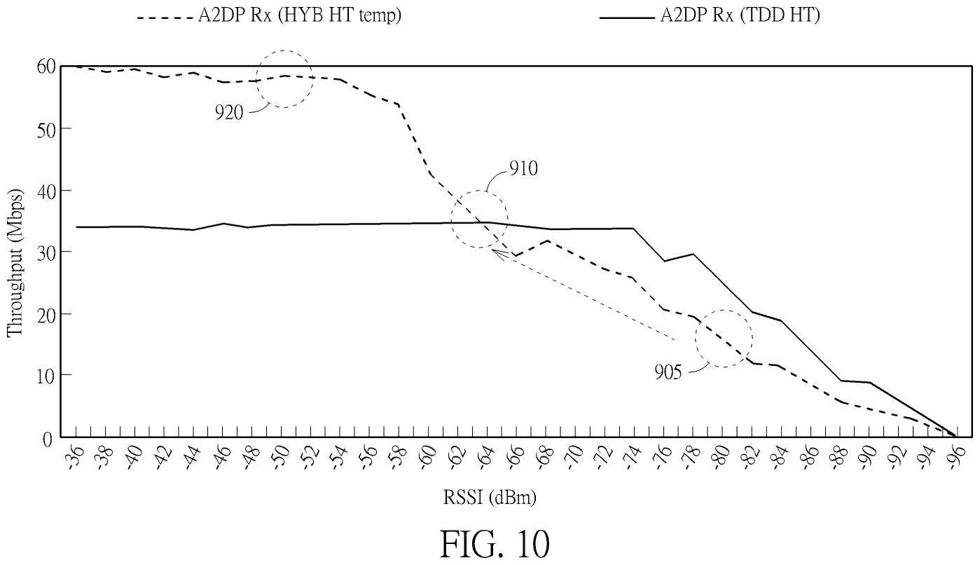

FIG. 10 illustrates an operation of monitoring the Rx throughput (e.g., the current throughput such as the FDD throughput FDD_Tput) while the RSSI (e.g., the current RSSI Cur_RSSI) is increasing according to an embodiment of the present invention, where the Rx throughput may increase from a lower value to reach the optimal switching point. For better comprehension, assume that the correct value of the signal strength threshold RSSI_TH may be equal to −64 (dBm), but the present invention is not limited thereto. According to some embodiments, the correct value of the signal strength threshold RSSI_TH may vary, and more particularly, may be equal to any value among some other values. In addition, assuming that the initial value of the signal strength threshold RSSI_TH has been erroneously set as −80 (dBm), and the RSSI (e.g., the current RSSI Cur_RSSI) is increasing, from low to high. When the RSSI (e.g., the current RSSI Cur_RSSI) is greater than −77 (dBm), since Cur_RSSI>(RSSI_TH+RSSI_TH_margin1 with RSSI_TH_margin1=3 (which may make the determination result of Step S16 be “No” to proceed downward to Step S19 as shown in FIG. 8), the communication control circuit 112 such as the Wi-Fi control circuit 1121 may try the FDD throughput FDD_Tput first rather than stopping the protection function directly. When FDD_Tput<TDD_Tput (which may make the determination result of Step S19 be “Yes” to proceed downward to Step S20 as shown in FIG. 8), it will keep triggering enabling the protection function and updating the signal strength threshold RSSI_TH until the signal strength threshold RSSI_TH is equal to −64 (dBm), for example, in a situation where the RSSI (e.g., the current RSSI Cur_RSSI) increases until the optimal switching point indicated by the intersection of the partial curves 910 is reached. For brevity, similar descriptions for this embodiment are not repeated in detail here.

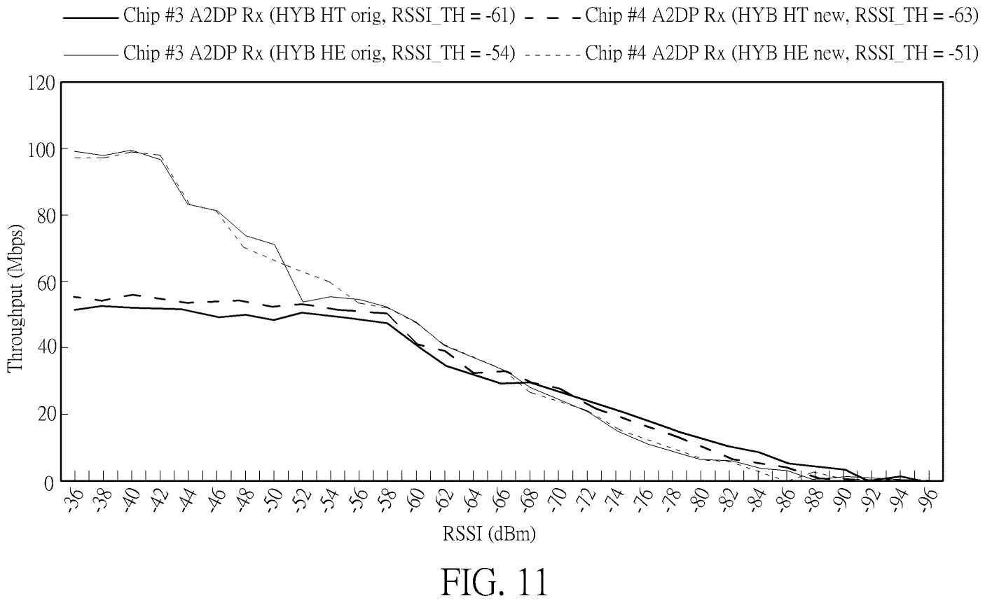

FIG. 11 illustrates the Rx throughput with respect to the RSSI for a chip #3 with manually fine-tuned threshold and a chip #4 with adaptively adjusted threshold according to an embodiment of the present invention, where the wireless communication device 110 may be implemented as any chip among the chips #3 and #4. For example, the signal strength threshold RSSI_TH of the chip #3 operating according to the hybrid strategy control scheme shown in the lower half part of FIG. 3 may be manually fine-tuned for the HT mode and the HE mode, respectively, and the signal strength threshold RSSI_TH of the chip #4 operating according to the adaptive strategy control scheme shown in FIG. 5 may be adaptively adjusted for the HT mode and the HE mode, respectively.

Regarding the HT mode, the curve corresponding to the chip #3 with the signal strength threshold RSSI_TH being manually fine-tuned as −61 (dBm) may indicate the Wi-Fi Rx performance when the Bluetooth profile is the A2DP (labeled “Chip #3 A2DP Rx (HYB HT orig, RSSI_TH=−61)” for brevity), and the curve corresponding to the chip #4 with the signal strength threshold RSSI_TH being adaptively adjusted as −63 (dBm) may indicate the Wi-Fi Rx performance when the Bluetooth profile is the A2DP (labeled “Chip #4 A2DP Rx (HYB HT new, RSSI_TH=−63)” for brevity). The wireless communication device 110 implemented as the chip #4 can automatically choose a suitable threshold such as −63 (dBm), which is very close to the manually fine-tuned value such as −61 (dBm), to be the signal strength threshold RSSI_TH for the HT mode.

Regarding the HE mode, the curve corresponding to the chip #3 with the signal strength threshold RSSI_TH being manually fine-tuned as −54 (dBm) may indicate the Wi-Fi Rx performance when the Bluetooth profile is the A2DP (labeled “Chip #3 A2DP Rx (HYB HE orig, RSSI_TH=−54)” for brevity), and the curve corresponding to the chip #4 with the signal strength threshold RSSI_TH being adaptively adjusted as −51 (dBm) may indicate the Wi-Fi Rx performance when the Bluetooth profile is the A2DP (labeled “Chip #4 A2DP Rx (HYB HE new, RSSI_TH=−51)” for brevity). The wireless communication device 110 implemented as the chip #4 can automatically choose a suitable threshold such as −51 (dBm), which is very close to the manually fine-tuned value such as −54 (dBm), to be the signal strength threshold RSSI_TH for the HE mode. For brevity, similar descriptions for this embodiment are not repeated in detail here.

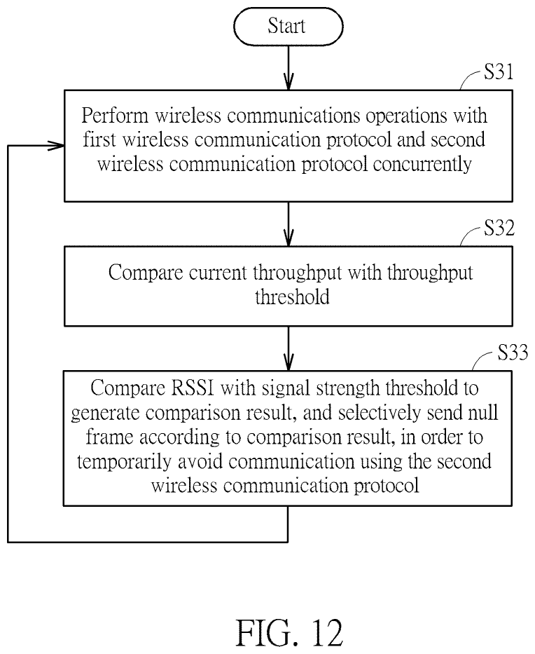

FIG. 12 illustrates a main working flow of the method according to an embodiment of the present invention, where a first communication control circuit and a second communication control circuit within the wireless communication device (e.g., the wireless communication device 110 shown in FIG. 1) operating according to the method may represent the communication control circuits 111 and 112 of the wireless communication device 110, respectively, and a first communication device and a second communication device that the first communication control circuit and the second communication control circuit are arranged to communicate with may represent the wireless communication devices 101 and 102, respectively. For example, the wireless communication device 110 (or the communication control circuits 111 and 112, such as the Bluetooth control circuit 111_1 and the Wi-Fi control circuit 112_1) may operate according to the working flow shown in FIG. 12.

In Step S31, the wireless communication device 110 may utilize the communication control circuit 111 such as the Bluetooth control circuit 111_1 and the communication control circuit 112 such as the Wi-Fi control circuit 112_1 to perform multiple wireless communication operations with the first wireless communication protocol and the second wireless communication protocol (e.g., the Rx and/or Tx operations in any combination among the combinations {310, 311, 312} shown in FIG. 3, such as the Wi-Fi Rx and BT Rx operations in the combination 310, the Wi-Fi Rx and BT Tx operations in the combination 311, and the Wi-Fi Tx and BT Tx operations in the combination 312) concurrently, for example, in the FDD manner.

In Step S32, the wireless communication device 110 may utilize the communication control circuit 112 such as the Wi-Fi control circuit 112_1 to monitor a current throughput such as the aforementioned current throughput (e.g., the FDD throughput FDD_Tput), and more particularly, compare the current throughput with the aforementioned throughput threshold (e.g., the pre-calculated throughput such as the TDD throughput TDD_Tput) to determine whether the current throughput (e.g., the FDD throughput FDD_Tput) reaches the pre-calculated throughput (e.g., the TDD throughput TDD_Tput) to generate at least one determination result such as the aforementioned at least one determination result, for adaptively determining the signal strength threshold RSSI_TH according to the aforementioned at least one determination result (e.g., the determination result indicating whether the current throughput reaches the pre-calculated throughput).

In Step S33, the wireless communication device 110 may utilize the communication control circuit 112 such as the Wi-Fi control circuit 112_1 to compare the RSSI (e.g., the current RSSI Cur_RSSI) of the communication control circuit 112, such as the RSSI (e.g., the current RSSI Cur_RSSI) in the communication using the second wireless communication protocol, with the signal strength threshold RSSI_TH to generate at least one comparison result such as the aforementioned at least one comparison result, and selectively send the predetermined wireless communication frame (or the protection frame) such as the null frame to the wireless communication device 102 such as the Wi-Fi communication device 102_1 according to the aforementioned at least one comparison result (e.g., the comparison result indicating whether the current RSSI Cur_RSSI is less than the signal strength threshold RSSI_TH), in order to temporarily avoid communication using the second wireless communication protocol (e.g., the communication with the wireless communication device 102 such as the Wi-Fi communication device 102_1).

After the execution of Step S33 is completed, the wireless communication device 110 (or the communication control circuits 111 and 112, such as the Bluetooth control circuit 111_1 and the Wi-Fi control circuit 112_1) may proceed to Step S31, and more particularly, continue performing the coexistence control 510 based on the adaptive threshold adjustment 520 as shown in FIG. 5, but the present invention is not limited thereto. For example, the communication control circuit 111 such as the Bluetooth control circuit 111_1 and the communication control circuit 112 such as the Wi-Fi control circuit 1121 may perform the associated operations of the combinations {310, 311, 312, 313, 314} in the modes M0, M1, M2, M3 and MP, and perform the adaptive threshold adjustment 520 to adaptively adjust the signal strength threshold RSSI_TH, for guaranteeing the correctness of the determination of whether the aforementioned predetermined condition is met, in order to properly switch among the modes M1 and MP and therefore prevent the concave issue mentioned above. For brevity, similar descriptions for this embodiment are not repeated in detail here.

For better comprehension, the method may be illustrated with the working flow shown in FIG. 12, but the present invention is not limited thereto. According to some embodiments, one or more steps may be added, deleted, or changed in the working flow shown in FIG. 12. For example, the operations of at least one portion of steps (e.g., a portion of steps or all steps) among Steps S11 to S21 in the working flow shown in FIG. 7 and FIG. 8 may be integrated into the working flow shown in FIG. 12. For brevity, similar descriptions for these embodiments are not repeated in detail here.

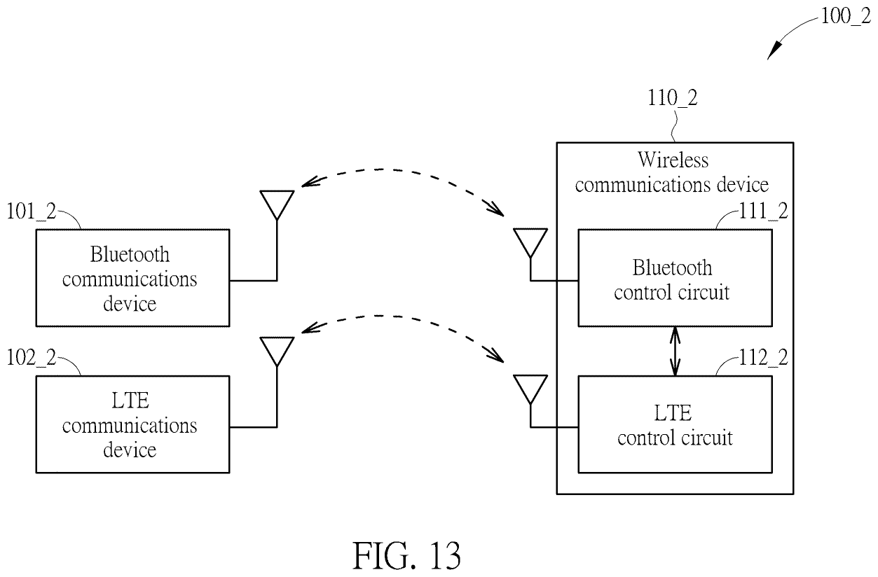

FIG. 13 is a diagram illustrating a second example of the wireless communication system 100 shown in FIG. 1, such as a wireless communication system 1002, where the wireless communication system 1002 may comprise a Bluetooth communication device 101_2 (e.g., a BLE communication device), an LTE communication device 102_2 and a wireless communication device 110_2, and the wireless communication device 1102 may comprise a Bluetooth control circuit 111_2 (e.g., a BLE control circuit) and an LTE control circuit 112_2. The Bluetooth communication device 1012, the LTE communication device 102_2 and the wireless communication device 1102 may be taken as examples of the wireless communication devices 101, 102 and 110, respectively, and the Bluetooth control circuit 111_2 and the LTE control circuit 112_2 may be taken as examples of the communication control circuits 111 and 112, respectively. For brevity, similar descriptions for this embodiment are not repeated in detail here.

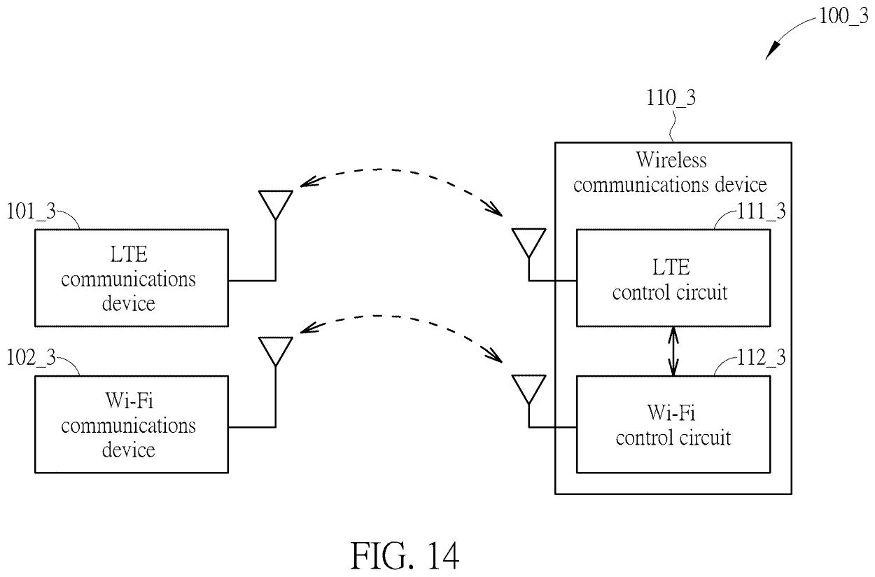

FIG. 14 is a diagram illustrating a third example of the wireless communication system 100 shown in FIG. 1, such as a wireless communication system 100_3, where the wireless communication system 100_3 may comprise an LTE communication device 101_3, a Wi-Fi communication device 102_3 and a wireless communication device 110_3, and the wireless communication device 1103 may comprise an LTE control circuit 111_3 and a Wi-Fi control circuit 112_3. The LTE communication device 101_3, the Wi-Fi communication device 102_3 and the wireless communication device 1103 may be taken as examples of the wireless communication devices 101, 102 and 110, respectively, and the LTE control circuit 111_3 and the Wi-Fi control circuit 1123 may be taken as examples of the communication control circuits 111 and 112, respectively. For brevity, similar descriptions for this embodiment are not repeated in detail here.

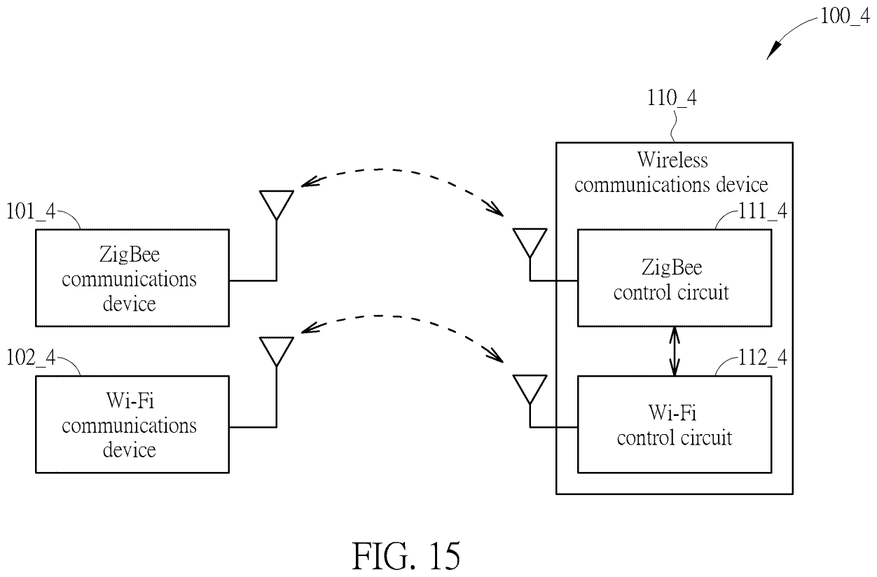

FIG. 15 is a diagram illustrating a fourth example of the wireless communication system 100 shown in FIG. 1, such as a wireless communication system 100_4, where the wireless communication system 100_4 may comprise a ZigBee communication device 1014, a Wi-Fi communication device 102_4 and a wireless communication device 110_4, and the wireless communication device 1104 may comprise a ZigBee control circuit 111_4 and a Wi-Fi control circuit 112_4. The ZigBee communication device 101_4, the Wi-Fi communication device 102_4 and the wireless communication device 1104 may be taken as examples of the wireless communication devices 101, 102 and 110, respectively, and the ZigBee control circuit 111_4 and the Wi-Fi control circuit 112_4 may be taken as examples of the communication control circuits 111 and 112, respectively. For brevity, similar descriptions for this embodiment are not repeated in detail here.

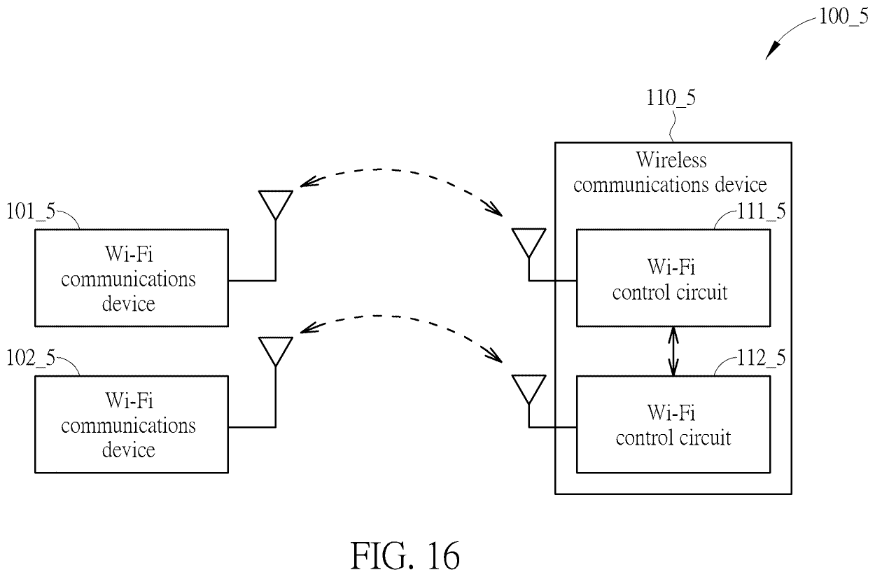

FIG. 16 is a diagram illustrating a fifth example of the wireless communication system 100 shown in FIG. 1, such as a wireless communication system 100_5, where the wireless communication system 100_5 may comprise a Wi-Fi communication device 1015, a Wi-Fi communication device 102_5 and a wireless communication device 110_5, and the wireless communication device 1105 may comprise a Wi-Fi control circuit 111_5 and a Wi-Fi control circuit 112_5. The Wi-Fi communication device 101_5, the Wi-Fi communication device 102_5 and the wireless communication device 1105 may be taken as examples of the wireless communication devices 101, 102 and 110, respectively, and the Wi-Fi control circuit 111_5 and the Wi-Fi control circuit 112_5 may be taken as examples of the communication control circuits 111 and 112, respectively. For brevity, similar descriptions for this embodiment are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing coexistence control based on adaptive threshold adjustment in a wireless communication device configured to operate with a first wireless communication protocol and a second wireless communication protocol, the method comprising:
performing wireless communication operations with the first wireless communication protocol and the second wireless communication protocol concurrently;
comparing a current throughput with a throughput threshold;
in response to the current throughput being less than the throughput threshold, comparing a received signal strength indicator (RSSI), in communication using the second wireless communication protocol, with a signal strength threshold to generate at least one comparison result; and
selectively sending a null frame according to the at least one comparison result, in order to temporarily avoid communication using the second wireless communication protocol.

2. The method of claim 1, wherein performing the wireless communication operations with the first wireless communication protocol and the second wireless communication protocol concurrently further comprises:
performing the wireless communication operations with the first wireless communication protocol and the second wireless communication protocol concurrently in a frequency-division duplexing (FDD) manner;
wherein the current throughput represents a FDD throughput in a situation where the wireless communication operations with the first wireless communication protocol and the second wireless communication protocol are performed concurrently in the FDD manner.

3. The method of claim 2, wherein performing the wireless communication operations with the first wireless communication protocol and the second wireless communication protocol concurrently in the FDD manner further comprises:
performing packet transmission and packet reception via different radio frequency channels.

4. The method of claim 1, wherein performing the wireless communication operations with the first wireless communication protocol and the second wireless communication protocol concurrently further comprises:
in communication using the first wireless communication protocol, transmitting a first packet to a first communication device and receive a third packet from the first communication device via a first radio frequency channel; and
in communication using the second wireless communication protocol, transmitting a second packet to a second communication device and receive a fourth packet from the second communication device via a second radio frequency channel.

5. The method of claim 1, wherein selectively sending the null frame according to the at least one comparison result comprises sending the null frame in response to at least one predetermined condition being met, wherein the at least one predetermined condition comprises a first predetermined condition, and the first predetermined condition represents that the RSSI is less than the signal strength threshold.

6. The method of claim 5, wherein the at least one predetermined condition further comprises a second predetermined condition, wherein the second predetermined condition represents that transmission duty of the first communication control circuit reaches a first predetermined threshold.

7. The method of claim 1, wherein an operation of comparing the current throughput with the throughput threshold is performed at least one time to determine whether the current throughput reaches the throughput threshold to generate at least one determination result; and the at least one determination result comprises a first determination result indicating that the current throughput is less than the throughput threshold, and the wireless communication device is arranged to update the signal strength threshold in response to the first determination result.

8. The method of claim 7, wherein the at least one determination result further comprises a second determination result indicating that the current throughput is greater than the throughput threshold, and the wireless communication device is arranged to prevent updating the signal strength threshold in response to the second determination result.

9. The method of claim 1, wherein an operation of comparing the current throughput with the throughput threshold is performed at least one time to determine whether the current throughput reaches the throughput threshold to generate at least one determination result; and the at least one determination result further comprises a second determination result indicating that the current throughput is greater than the throughput threshold, and the wireless communication device is arranged to prevent updating the signal strength threshold in response to the second determination result.

10. The method of claim 1, wherein an operation of comparing the current throughput with the throughput threshold is performed at least one time to determine whether the current throughput reaches the throughput threshold to generate at least one determination result; and in response to a first determination result among the at least one determination result, the wireless communication device is arranged to update the signal strength threshold according to a latest value of the RSSI in communication using the second wireless communication protocol.

11. The method of claim 1, wherein an operation of comparing the current throughput with the throughput threshold is performed at least one time to determine whether the current throughput reaches the throughput threshold to generate at least one determination result; and the wireless communication device is arranged to perform an adaptive strategy control procedure for adaptively adjusting the signal strength threshold while performing the coexistence control, wherein the adaptive strategy control procedure comprises:
configuring at least one function related to communication using the second wireless communication protocol to start performing the coexistence control, wherein configuring the at least one function comprises setting an enabling or disabling state of any function among the at least one function;
setting a timer for controlling timing of repeatedly executing at least one partial working flow within a working flow of the adaptive strategy control procedure;
determining whether the current throughput reaches the throughput threshold to generate a first determination result among the at least one determination result;
updating the signal strength threshold in response to the first determination result among the at least one determination result; and
enabling a first function among the at least one function in response to the first determination result among the at least one determination result.

12. The method of claim 11, wherein the adaptive strategy control procedure further comprises:
calculating the throughput threshold according to at least one factor related to communication using the second wireless communication protocol.

13. The method of claim 12, wherein the at least one factor comprises one or a combination of a peak throughput based on a predetermined wireless communication mode, and an airtime sharing ratio that is based on at least one predetermined profile of at least one of communication using the first wireless communication protocol and communication using the second wireless communication protocol.

14. The method of claim 11, wherein the adaptive strategy control procedure further comprises:
comparing the RSSI, in communication using the second wireless communication protocol, with the signal strength threshold plus a predetermined margin regarding the signal strength threshold to generate a first comparison result among the at least one comparison result;
wherein an operation of determining whether the current throughput reaches the throughput threshold to generate the first determination result among the at least one determination result is performed in response to the first comparison result.

15. The method of claim 14, wherein the at least one comparison result comprises multiple comparison results, and an operation of comparing the RSSI, in communication using the second wireless communication protocol, with the signal strength threshold plus the predetermined margin is performed multiple times to generate the multiple comparison results, respectively, wherein the multiple comparison results comprise the first comparison result and a second comparison result; and the adaptive strategy control procedure further comprises:
in response to the second comparison result, comparing the RSSI, in communication using the second wireless communication protocol, with a checking-related signal strength threshold, in order to re-configure the at least one function, wherein re-configuring the at least one function comprises updating said enabling or disabling state of the any function among the at least one function.

16. A wireless communication device, configured to operate with a first wireless communication protocol and a second wireless communication protocol, the wireless communication device comprising:
a first communication control circuit, arranged to perform communication control in compliance with the first protocol; and
a second communication control circuit, arranged to perform communication control in compliance with the second wireless communication protocol;
wherein:
the first communication control circuit and the second communication control circuit are arranged to perform wireless communication operations with the first wireless communication protocol and the second wireless communication protocol concurrently;
the second communication control circuit is arranged to compare a current throughput with a throughput threshold;
in response to the current throughput being less than the throughput threshold, the second communication control circuit is arranged to compare a received signal strength indicator (RSSI), in communication using the second wireless communication protocol, with a signal strength threshold to generate at least one comparison result; and
the second communication control circuit is arranged to selectively send a null frame according to the at least one comparison result, in order to temporarily avoid communication using the second wireless communication protocol.

17. The wireless communication device of claim 16, further comprising:
at least one first antenna, coupled to the first communication control circuit, wherein the first communication control circuit is arranged to perform wireless communication through the at least one first antenna; and
at least one second antenna, coupled to the second communication control circuit, wherein the second communication control circuit is arranged to perform wireless communication through the at least one second antenna.
